(19) United States
(12) Patent Application Publication
(10) Pub. No.: US 2017/0191306 A1
(43) Pub. Date: Jul. 6, 2017

(54) Removable Ballistic-Resistant Door Barricade

(71) Applicant: Blacknight Holdings, LLC, Plainfield, IL (US)

(72) Inventors: Alex J. Falesch, Oswego, IL (US); Ryan Walsh, Aurora, IL (US); Christopher LeClair, Chicago Ridge, IL (US)

(21) Appl. No.: 15/331,533

(22) Filed: Oct. 21, 2016

Related U.S. Application Data
(60) Provisional application No. 62/244,705, filed on Oct. 21, 2015.

(51) Int. Cl. E06B 5/10; E05C 19/18; E05G 5/00; F41H 5/24; F41H 5/013; E05C 19/00; E05B 1/00

(52) U.S. Cl. CPC E06B 5/10; E05C 19/003; E05C 19/188; E05B 1/0061; F41H 5/24; F41H 5/013; E05G 5/003

(57) ABSTRACT

A door barricade configured to secure a door from an outside threat can include a ridged bulletproof plate. The door barricade can be connected to the door via a fastener. In some embodiments, the fastener is an L-bracket. In other embodiments, the fastener is a ballistic nylon mechanism. The door barricade can also include at least one crossbar and at least one foot to help prevent the door from being forced open. The door barricade can also include a carrying handle to allow for easier deployment of the barricade. In some embodiments, the plate can include a door handle notch that can be covered with a door handle cover. In other or the same embodiments, a door skirt is present. In some embodiments, side panels are attached to the barricade via mounting brackets.

### CROSS-REFERENCE TO RELATED APPLICATIONS

This application is related to and claims priority benefits from U.S. Provisional Patent Application No. 62/244,705 filed Oct. 21, 2015 entitled “Removable Ballistic-Resistant Door Barricade.” The '705 application is hereby incorporated by reference in its entirety.

### FIELD OF THE INVENTION

The present invention relates to a removable and/or rapidly deployable ballistic barrier that can be used to protect those inside a room from threats originating outside a point of entry.

### BACKGROUND OF THE INVENTION

Although violent crime as a whole has decreased over the last two decades, the frequency of mass casualty shootings such as school shootings has dramatically risen.

One F.B.I. study looked at the frequency of active shooter incidents from 2000 to 2013. Over that time span there were 160 incidents (an average of 11.4 per year) leading to 486 fatalities. What is most troublesome is the sharp rise in the frequency of these incidents. Between 2000 and 2007 incidents occurred at an average rate of 6.4 per year. Between 2007 and 2013, the rate more than doubled to an average of 16.4 per year.

Active shootings at schools are often the deadliest incidents. Of the 160 incidents studied, about a fourth involved schools and resulted in 117 deaths. For example, the Virginia Tech shootings resulted in 32 deaths while the Sandy Hook Elementary School shootings left 27 dead.

While permanent security installations such as metal detectors and security measures such as frequent pat downs could help prevent mass shootings, schools and businesses often choose not to implement these devices and/or techniques as they are too costly, invasive, and/or permanent and/or make the environment too militaristic. Instead of utilizing these militaristic options, most schools and businesses employ lockdown procedures which are meant to spread the potential victims across the building in various rooms and buy time for local law officials to subdue the shooter(s).

It is not surprising that over half of school shootings take place inside classrooms. Classrooms offer little in defensive posturing and often have a single point of entry that can easily be controlled by the shooter(s). This is especially true when the potential victims are without weapons, as is often the case due to the policies prohibiting firearms on school grounds.

With potential victims locking themselves in rooms, the strength of barrier between the shooter and the potential victims is critical to minimizing casualties. Unfortunately, these barriers are typically interior doors which are not designed to take the violent force of ballistic, mechanical and/or explosive forces employed by active shooters determined to cause mass fatalities.

What is needed is a countermeasure that can be rapidly deployed by potential victims of mass shootings to barricade doors which are often the only barrier between them and the shooter(s). The barricade should be able to last until the police are able to subdue or take out the shooter(s). Ideally the device should be simple, easy to use, and reliable. In some embodiments, the device should not be a permanent fixture. Such a device could save hundreds, if not thousands of lives over the next decades.

### SUMMARY OF THE INVENTION

A door barricade can include a plate; a fastener; a crossbar; a foot; and a carrying handle. In some embodiments, the plate is ridged, fireproof and/or bulletproof. In certain embodiments, the plate can be made of a nonhomogeneous composition. The crossbar can be telescopic and/or made of steel. In certain embodiments, the crossbar has a locking mechanism.

In some embodiments, the fastener is an L-bracket. In other embodiments, the fastener is a ballistic nylon mechanism.

In some embodiments, the door barricade can also include a door handle cover, wherein the door handle cover is configured to cover a door handle notch present in the plate.

In some embodiments, the door barricade can also include a door skirt. In other or the same embodiments, the door barricade can also include at least one mounting bracket and a side panel, wherein the side panel is configured to attach to the mounting bracket.

In some embodiments, the door barricade can include a second foot attached to the first foot via a feet bar.

### BRIEF DESCRIPTION OF THE DRAWINGS

FIG. 1 is an exploded perspective view of an example embodiment of a door barricade and a standard door.

FIG. 2 is a front view of the door barricade of FIG. 1.

FIG. 3 is a back view of the door barricade of FIG. 1.

FIG. 4 is a side view of the door barricade of FIG. 1.

FIG. 5 is a front view of another example embodiment of a door barricade.

FIG. 6 is a front view of another example embodiment of a door barricade.

FIG. 7 is a front view of another example embodiment of a door barricade.

FIG. 8 is a front view of another example embodiment of a door barricade.

FIG. 9 is a front view of another example embodiment of a door barricade.

FIG. 10 is a perspective view of bar receiving ringlets in some embodiments.

### DETAILED DESCRIPTION OF PREFERRED EMBODIMENT(S)

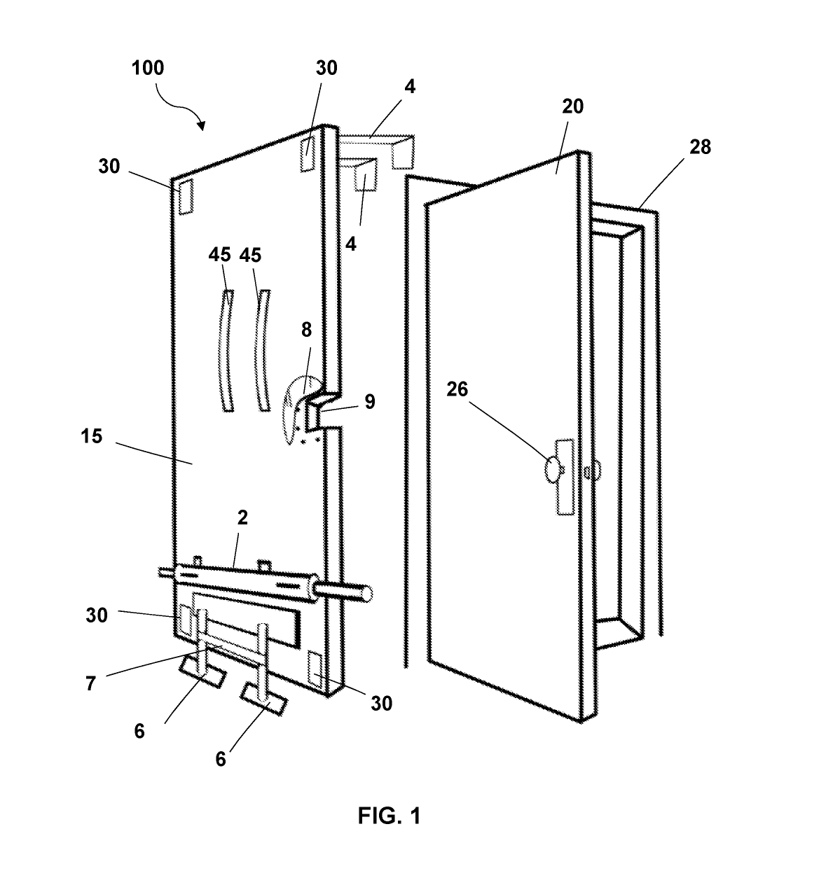

Turning to FIG. 1, an attacker in a mass shooting can overcome traditional door 20 by applying force to weak points such as the hinges (not shown) of door 20 or where the door jamb meets frame 28. Even if door 20 has high ballistic resistance, it is still vulnerable to failure at its points of motion and security, i.e. hinges and locks. A determined assailant can bypass the hinges or door jamb in a matter of seconds with minimal training and tools. Hinges and door jambs are even easier to defeat with firearms.

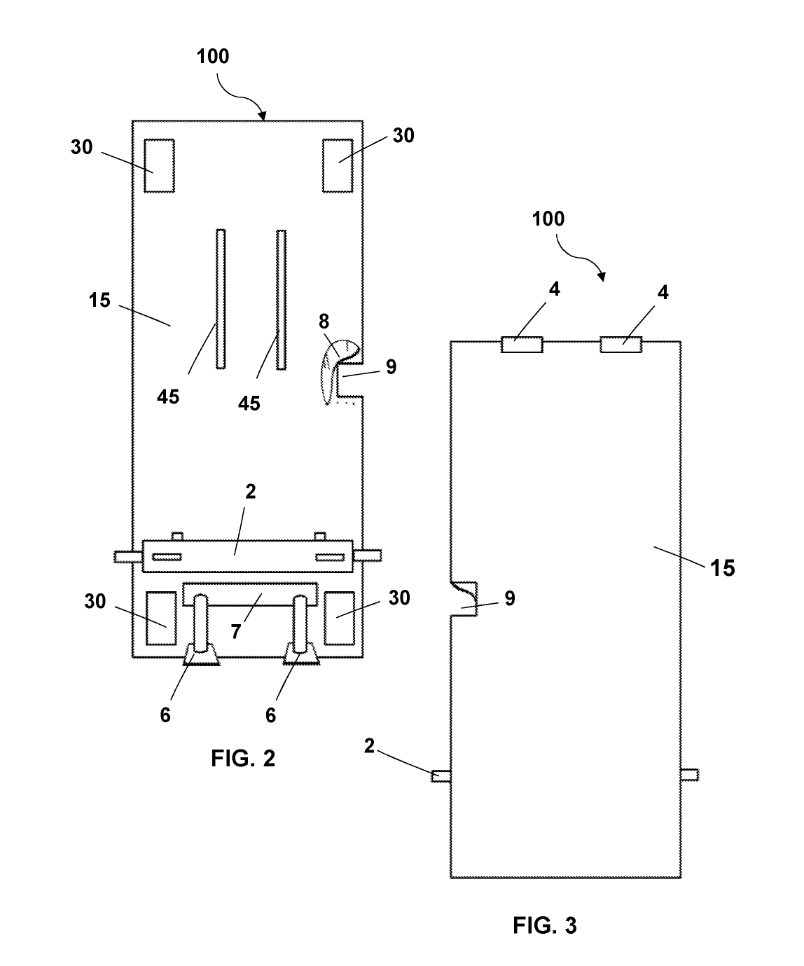

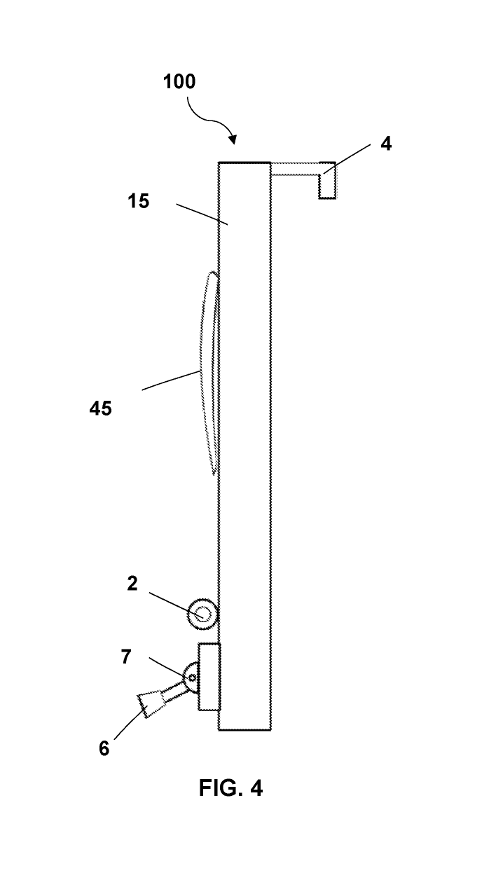

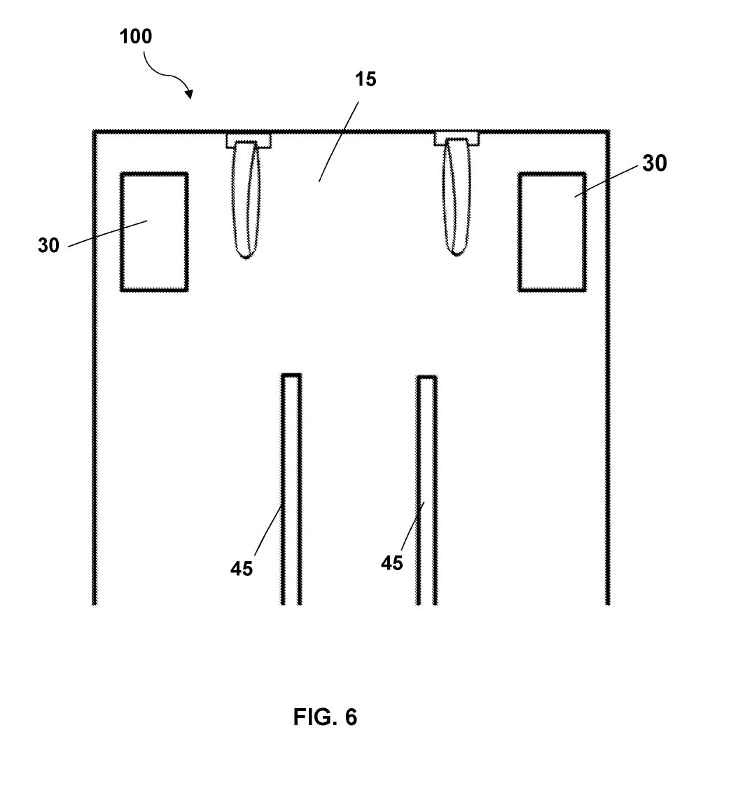

Ballistic door barricades 100, as illustrate in FIGS. 1-6, are designed to reinforce and strengthen the inherent weak points of door 20 and provide a safer and more secure location for potential victims in the event of a mass shooting. Door barricades 100 can act as rapidly deployable protective measures against a multitude of threats including home burglaries and also allow full use of door 20 when it is not in use. In many embodiments, door barricade 100 can be deployed in under fifteen seconds.

Door barricade 100 can be customizable to fit a wide variety of doors without requiring any temporary or permanent alterations or modification to door 20 or door frame 28.

Door barricade 100 can be configured to work with inward and/or outward opening doors as well as other common configurations including but not limited to doors with side window(s) adjacent to the door as well as doors with window(s) mounted within the door itself.

Door barricade 100 is shown with fasteners 4, bar(s) 2, feet 6, plate 15, carrying handles 45 and mounting brackets 30. Among other things, fasteners 4, bar(s) 2, and feet 6 can overcome a failure in the traditional locking mechanism of door 20.

Optional quick-fasten clips (not shown) can add additional side protection on both sides and/or unilaterally.

Door barricade 100 includes plate 15. In at least some embodiments, plate 15 is rigid and hinders, if not prevents, an assailant from moving door barricade 100 and manipulating door handle 26. Plate 15 adds strength to door barricade 100 and door 20. This reduces the potential for a catastrophic failure of door barricade 100. In some embodiments, plate 15 has an outer encasing that can be homogeneous or constructed from a plurality of materials. These materials can include, but are not limited to, fabrics, composite shells, leather or comparable synthetics, metals, polymers, or other materials capable of weathering ballistic impacts. In some embodiments, the encasing does not interfere with the operation of mechanisms mentioned herein.

In embodiments having fabric encasings, fabrics can include but are not limited to natural fiber weaves, synthetic fiber weaves and combinations thereof. Fabric encasements can be held together by methods which can include but are not limited to stitching, rivets, hook and loop fasteners, buttons, snap fittings, zippers or links. In some embodiments, fabric encasings are designed to be removable to allow for inspection or cleaning of plate 15.

In embodiments having hard shell encasings, hard shells can be constructed from materials including but not limited to polymers, metals, and combinations thereof. In such embodiments, the hard shell encasing can be held together by methods including but not limited to the use of adhesives, pins, bolts, screws, hook and loop fasteners, rivets and buttons. In some embodiments, the hard shell encasing is designed to be removable to allow for cleaning or inspection of the plate contained therein.

In embodiments wherein an encasing for plate 15 is non-homogenous, combinations of aforementioned materials or suitable substitutes can be used. In such embodiments, aforementioned methods of attachment or suitable substitutes are employed. In some embodiments, a non-homogenous encasing is designed to be removable to allow for cleaning or inspection of the plate contained therein.

In some embodiments, plate 15 is made of a non-homogenous composite of various layers of different materials configured to obtain a desired ballistic resistance. In some embodiments, these materials can include, but not be limited to, fiberglass, synthetic fiber weaves, natural fiber weaves, poly-paraphenylene terephthalamide, carbon fiber, polyester, resins, non-Newtonian fluids, polymer products (including liquid crystal polymer products), ultra-high-molecular-weight polyethylene products, and various physical configurations of metals (such as aluminum, steel and titanium) to include plating and mesh.

In at least one embodiment, plate 15 is made of 3 mm steel plating, polyester resin, and fiberglass weave. In some embodiments, the materials are bound together in a polymer or elastomer chemically reacted suspension so that the assembly performs as one rigid structure capable of withstanding ballistic trauma, blunt force trauma, ballistic and explosive fragmentation, extreme temperatures and/or direct heat as well as attempts at mechanical breach through plate 15. In some embodiments, layers are held together by adhesion methods to include, but not be limited to, resins, adhesives, interweaving, and stitching. In other embodiments, plate 15 is made of a homogeneous material that is bulletproof, and these materials can include, but not be limited to, fiberglass, synthetic fiber weaves, natural fiber weaves, poly-paraphenylene terephthalamide, carbon fiber, polyester, resins, non-Newtonian fluids, polymer products (including liquid crystal polymer products), ultra-high-molecular-weight polyethylene products, and various physical configurations of metals (such as aluminum, steel and titanium) to include plating and mesh.

In some embodiments, plate 15 has the ability to stop pistol calibers at point blank range. In the same or alternative embodiments, where more mobility is desired, plate 15 may not be cable of stopping high caliber rifle rounds; however, it can significantly slow the rounds down so they cause less damage. In other embodiments, plate 15 can stop high powered rifle rounds.

Door barricade 100 can include at least one foot 6, such as the two feet shown in FIG. 1. In some embodiments, two feet 6 are placed at the bottom corners of door barricade 100 about one fifth of the way in from each side. In other embodiments, feet 6 are placed at the bottom corners of door barricade 100 between one tenth and one third of the way in from each side

In certain embodiments, feet 6 are extendable to adjust for the height of various doors. This adjustability can be achieved in a number of ways including, but not limited to, detents, screw based mechanisms, or other forms of adjustment that do not compromise the structural strength and integrity of feet 6.

When deployed, feet 6 apply pressure from door barricade 100 into the floor and lock into place acting as a type of kick stand. In some embodiments, this pressure is applied at essentially a forty-five-degree angle between the floor and door 20. In some embodiments, this pressure is applied between a ten-degree and an eighty-degree angle between the floor and door 20. This pressure helps in preventing, or at least reducing the chance that door barricade 100 can be pushed in by an attacker. It also acts to keep plate 15 firmly against door 20 in case fastener(s) 4 fail.

Feet 6 can be constructed from a variety of materials including, but not limited to, metals (such as titanium, aluminum and steel) and/or polymers. In some embodiments, feet 6 comprise a lightweight shell, an acting piston, a spring, an activation switch or toggle, and a charging bar. In some embodiments, the activation switch is designed to be ergonomic. In some embodiments, feet 6 are connected via feet bar 7 that allows feet 6 to be deployed or disengaged as a single unit. Feet 6 can be deployed by a variety of methods including, but not limited to, spring tension assistance, hydraulic pressure, and/or human force. In some embodiments with an emphasis on ergonomics, feet 6 (such as those with spring tension assistance or hydraulic pressure as listed above) can be activated by use of a user's hands, feet, cranial dome, or other convenient body part, depending on the placement of a deployment mechanism. The bottom of feet 6 can comprise materials including, but not limited to, rubber or other substances that provide high traction on a variety of surfaces.

In some embodiments, door barricade 100 is configured to be easily taken down and stored. In other or the same embodiments, door barricade 100 has carrying handles 45 which can be used to carry and/or grab door barricade 100. In at least some embodiments, door barricade 100 is relatively lightweight making it possible for a teacher or student of average strength to deploy it.

In some embodiments, carrying handles 45 are permanently affixed to the side of door barricade 100 that faces the protected room. In other or the same embodiments, carrying handles 45 are placed approximately halfway to two-thirds up door barricade 100 and about a third of the way in from the edge of their respective sides.

Carrying handles 45 can be oriented in a vertical fashion in order to facilitate the rapid deployment and removal of door barricade 100, although other orientations are possible. Carrying handles 45 can be positioned to increase leverage and allow for manipulation of door barricade 100 under duress.

Carrying handles 45 can be made of variety of materials including, but not limited to, cloth, ballistic nylon, metal, and/or rope. Carrying handles 45 can be fixed to door barricade 100 by a number of methods including, but not limited to, stitching, riveting, welding, and/or weaving.

Door barricade 100 can be secured to door 20 in a variety of ways including, but not limited to, rigid hook brackets and a flexible material such as a ballistic nylon that hangs over the top of door 20 and locks in place with both sides connecting to a metal plate that faces the outside to protect the ballistic nylon mounting system. The flexible material works well for certain structural variables such as wider frames or thicker doors.

Door barricade 100 attaches to door 20 in at least one embodiment via brackets 4 that hook over the top of door 20 and allow door 20 to be closed, securing brackets 4 of door barricade 100 between the top of door 20 and door frame 28.

In some embodiments, such as the embodiment illustrated in FIG. 1, fasteners 4 are L-brackets. In FIG. 1, door barricade 100 is mounted to door 20 by L-bracket fasteners 4. Bracket fasteners 4 can be made of metal and/or designed to hook over the top of door 20. In some embodiments, the shorter side bracket fastener 4 is configured to be on the exterior side of door 20 (that is the side of door 20 facing away from the potential victims). In some embodiments, door 20 is shut so fasteners 4 rest between the top of door 20 and door frame 28 and remain in place via gravity.

Fasteners 4 can be attached to door barricade 100 in a number of ways including, but not limited, to a steel plate (not shown) built into door barricade 100; bolts; rivets; screws; and/or adhesives. In particular, the steel plate method helps increase the strength of door barricade 100 and reduce, if not minimize, the chance of fastener(s) 4 acting as an inherent weak point of door barricade 100.

In embodiments that require adjustability in fasteners 4 (such as when door 20 is abnormally thick or thin), materials such as, but not limited to, ballistic nylon or synthetic-fiber straps can be configured to connect the top of plate 15 with a metal plate on the outer exposed surface of door 20. This configuration acts to hold door barricade 100 against door 20.

In some embodiments, crossbar 2 is fixed to plate 15. In some embodiments, bar 2 is made of steel. In other embodiments, bar 2 is made from other metals (such as titanium and aluminum) and/or of composite materials and/or polymers, depending on the desired strength to weight ratio for a given application. In other or the same embodiments, bar 2 is permanently mounted to plate 15. Bar 2 can be horizontally fixed to plate 15 so that it is oriented parallel to the floor. In some embodiments, bar 2 is vertically or diagonally fixed to plate 15. In some embodiments, the orientation of bar 2 is not fixed with respect to plate 15, and in such embodiments locking mechanisms for temporarily fixing the orientation of bar(s) 2 is/are provided.

In at least some embodiments, bar 2 adjusts to overlap the door frame 28 to help prevent breach attacks when door 20 is configured to open away from the interior of the safe area. In some embodiments, bar 2 can be adjustable away from plate 15 such that bar 2 can work with doors that are recessed into the door frames. Bar 2 can include at least one locking mechanism for locking the position of an extended bar and at least one extending mechanism for positioning the bar. These mechanisms can include, but are not limited to devices using pins, ball detents, springs and gears.

Since doors and frames come in various sizes, in some embodiments, bar 2 can have telescoping capabilities so it can be adjusted to meet the specific dimensions of a given door. In some embodiments, bar 2 is located about a third of the way up from the bottom of door 20; in other or the same embodiments bar 2 is located about a third of the way down from the top. In some embodiments, bar(s) 2 can be mounted to plate 15 by means including but not limited to rivets, bolts, pins, stitching, adhesives, brackets, and revolving fixtures.

In some embodiments, a bar or bars 2 can be operated by forces including, but not limited to, manual manipulations, hydraulic engagements, spring tensions or compressive forces. In some embodiments, bar(s) 2 can be operated by combinations of the aforementioned forces or other forces. Devices for enacting these forces can include, but are not limited to, levers, handles, wheels and buttons. In some embodiments, locking mechanism(s) can engage part-way through the telescoping process, allowing for a variety of adjustments to be made to the telescoped length of bar 2. In some embodiments, the orientation of bar 2 relative to the door frame 28 is fully adjustable, and can be locked in place at an orientation desired for a given application.

In some embodiments, two or more bars 2 are used. In some embodiments, one bar 2 is placed near the top end of door 20 and one bar 2 is placed near the bottom of door 20. For example, in embodiments such as those shown in FIGS. 1-6, after door barricade 100 is affixed to door 20 and door 20 is shut, bar 2 is extended past the vertical portions of door frame 28. This helps prevent, or at least reduces, the chance of door 20 from being pulled open in the event the standard locking mechanism on door 20 is compromised. In some embodiments, each bar 2 operates independently to allow for a variety of configurations. The number of crossbars and the orientation of each individual bar will vary with each application for which the chosen embodiment has been designed.

Door handle notch 9 can be included in plate 15 to allow rapid deployment of door barricade 100 and allow handle 26 and locking mechanism (not shown) to be used, especially when the crisis has passed or if the situation has changed and the potential victims must vacate the room such as if a fire has broken out in the room. Door handle notch 9 also allows plate 15 to lay flat against door 20.

In at least some embodiments, door handle notch allows door 20 to be used with door barricade 100 attached as long as bar 2 and feet 6 are disengaged. This allows door barricade to be a semi-permanent installation that need not be completely deployed in a crisis.

In some embodiments, door barricade 100 includes handle cover 8 which can in some embodiments be permanently affixed to the interior handle-side of door barricade 100. Handle cover 8 can be made of a flexible bulletproof cloth material that is designed to cover door handle 26 of door 20. Handle cover 8 can be attached to door barricade 100 in a number of ways including, but not limited to, stitching, riveting, hook-and-loop fasteners, or the use of adhesives.

Handle cover 8 is configured to prevent, or at least reduce, the entry of fragments or bullets into the room in the event the attacker decides to shoot the lock and door handle 26 assembly of door 20. Handle cover 8 aids in the protection of the individuals inside of the room if door handle 26 and/or locking mechanism are removed, shot out and/or damaged during an attack.

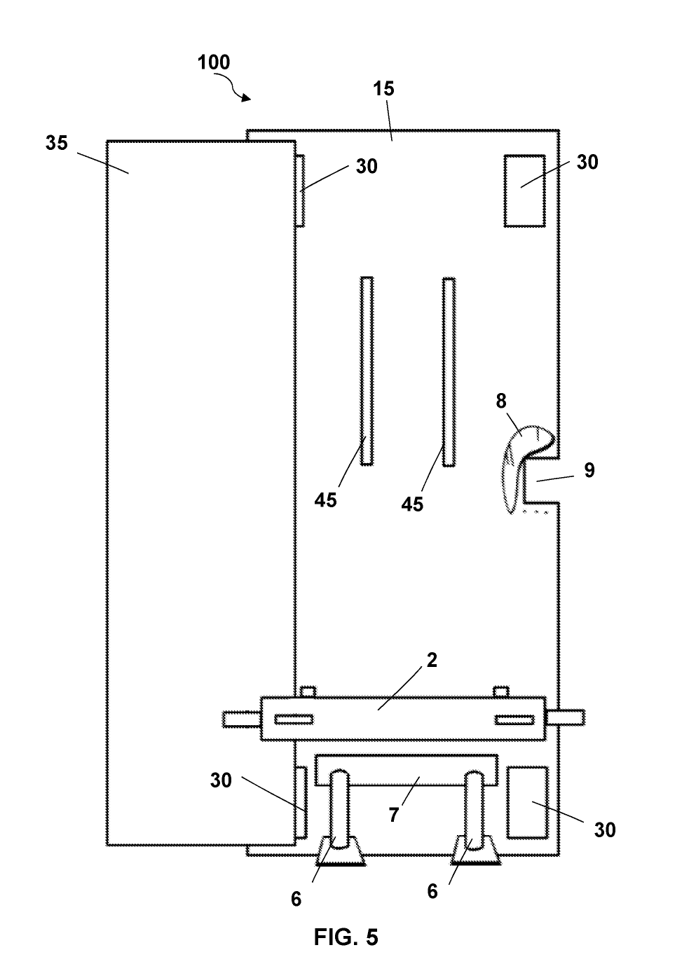

In some embodiments, one or more mounting brackets 30 are affixed to the interior facing side of door barricade 100. Mounting brackets 30 allow for side panels 35 (see FIG. 5) to be affixed to door barricade 100. Side panels 35 can be affixed to mounting brackets using a variety of mechanisms, including but not limited to, buckles, pins, straps, detents, cables, and/or locking bars.

In some embodiments, side panels 35 are affixed to door barricade 100 before door barricade is deployed on door 20. In other embodiments, such as when reducing the weight of door barricade 100 is important, side panels 35 can be attached to door barricade after it has been deployed on door 20.

Side panels 35 are especially useful in instances when door 20 has an adjacent sidelight (not shown). Side panels 35 can be made from a variety of materials including metal and other bullet-proof or resistant materials. In some embodiments, side panels 35 are made of the same material as door barricade 100. Side panels 35 together with mounting brackets 30 allow for a standardized door barricade 100 to be customized to be used with a wide variety of doors 20.

Side panels 35 can vary in all dimensions.

FIG. 1 shows four mounting brackets 30, however various numbers can be present depending on the location in which door barricade is being employed. In some embodiments, mounting brackets 30 are permanently affixed to plate 15. Mounting brackets 30 can include but are not limited to straps, buckles, clips, and/or slots and can be constructed of materials including, but not limited to, polymer plasters, metal, and ballistic nylon. Various methods of attaching mounting brackets 30 to door barricade 100 include, but are not limited to, stitching, rivets, welding, bolting, and/or screws.

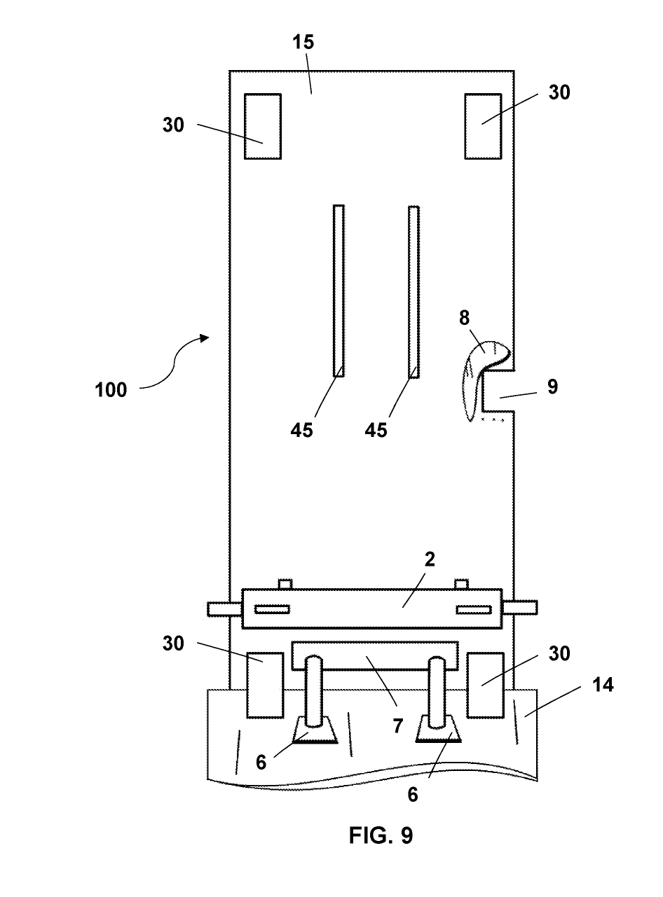

In some embodiments, such as the one shown in FIG. 9, door skirt 14 is affixed at the bottom of door barricade 100. In some embodiments, door skirt 14 is made of a soft ballistic material. In certain embodiments, door skirt 14 is bullet proof. Door skirt 14 can be attached to door barricade 100 by a variety of methods including, but not limited to, stitching, adhesives, weaving, clips, buckles and/or hook-and-loop fasteners. Door skirt 14 can vary in length and is intended to cover the gap found between the bottom of door 20 and the floor. Door skirt 14 is intended to reduce the likelihood of bullets or fragments from entering into the room from under door 20 as well as prevent, or at least hinder, the use of breaching devices that can be inserted under door 20.

In some embodiments, fixtures to plate 15 can be attached by a number of methods, which can include, but are not limited, to bolts, rivets, pins, screws, stitching, adhesives, welds and/or hook and loop fasteners.

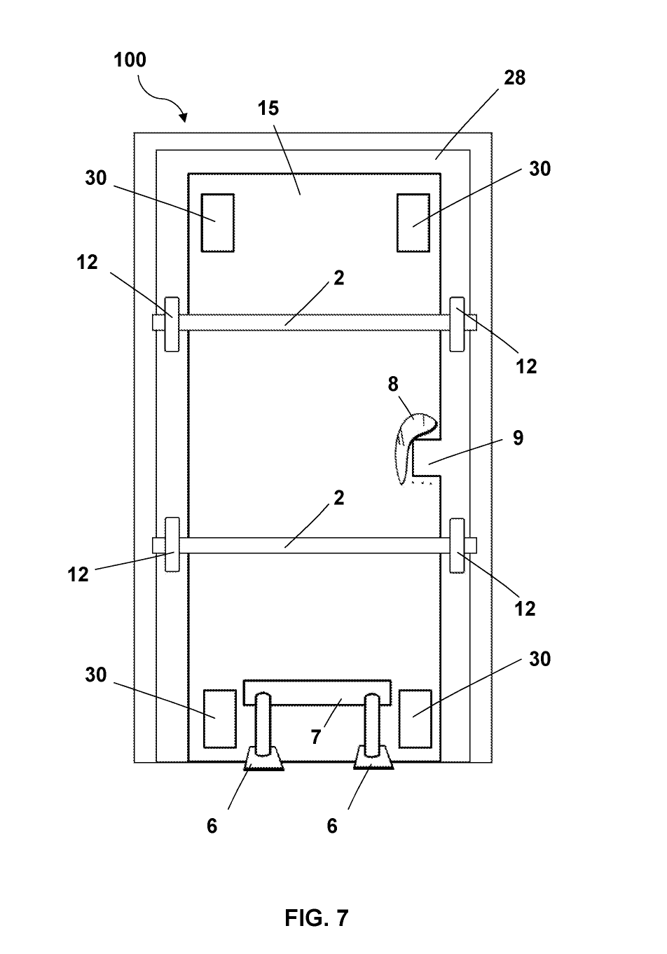

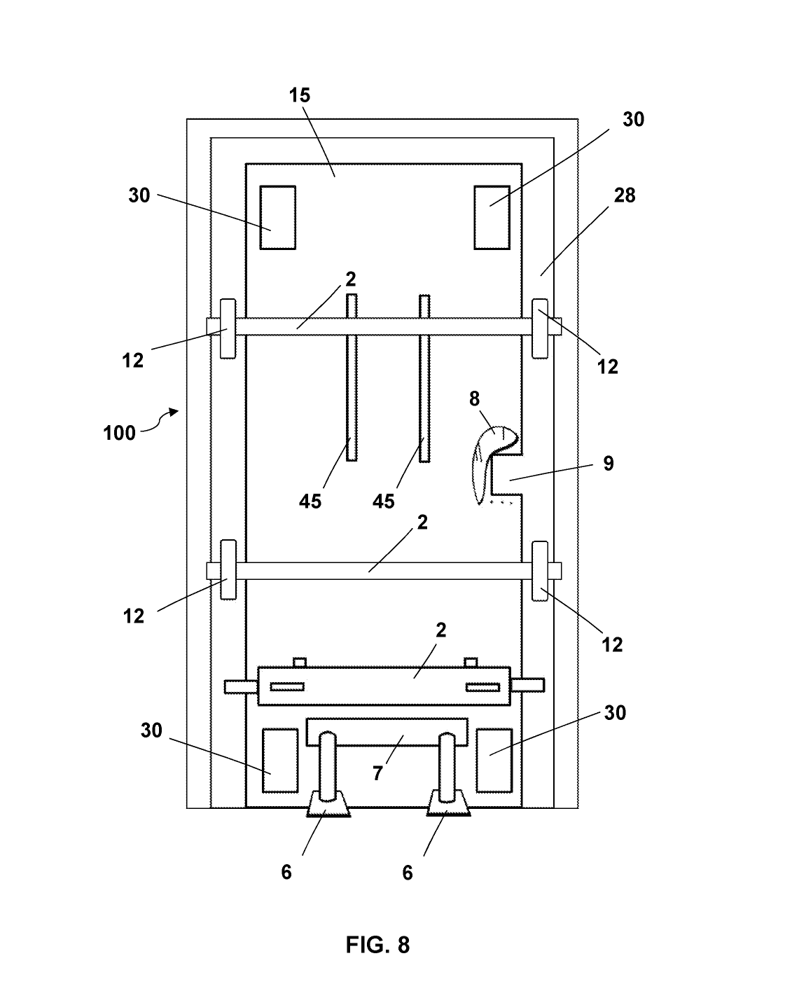

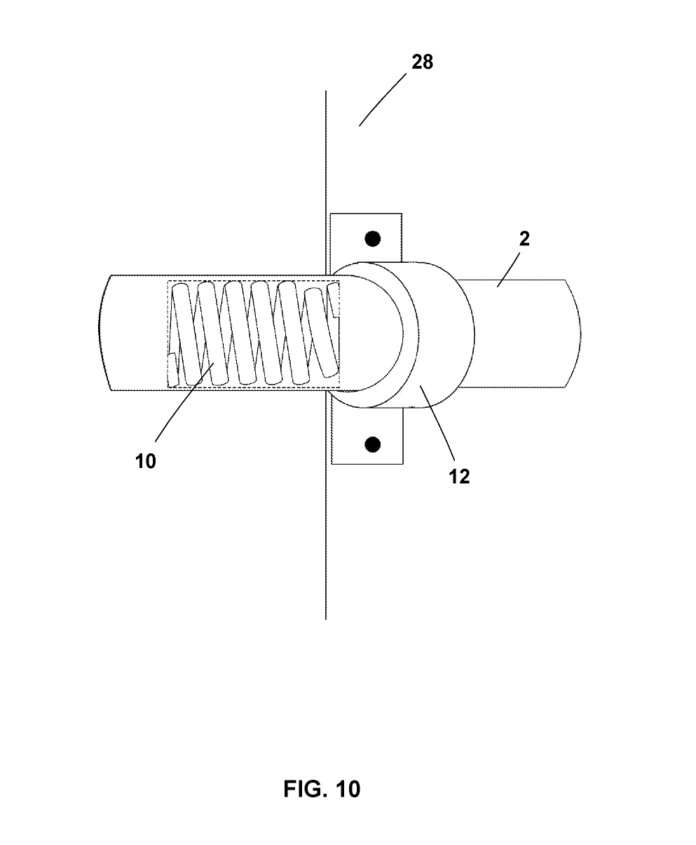

In some embodiments, such as that shown in FIG. 10 and particularly those in which bar(s) 2 is/are telescoping, receiving ringlet(s) 12 can be affixed to door frame 28 and positioned to engage with bar(s) 2. In the embodiment shown in FIG. 10, bar(s) 2 is/are telescoping, and are biased by an internal spring 10. In some embodiments, bar(s) 2 are telescoping and are not biased. In some embodiments, bar(s) 2 can slide into an extended position through the use of mechanisms including but not limited to gears, leaf springs, gas springs, or gravitational mechanisms. In embodiments such as those depicted in FIGS. 7 and 8, bars 2 can be configured to engage with receiving ringlets 12 even when bars 2 are not telescoping. In some embodiments, not all of bar(s) 2 can engage with receiving ringlets 12. In some embodiments, all of bar(s) 2 can engage with receiving ringlets 12. In some embodiments, such as that depicted in FIG. 8, some bars are telescoping while others are not.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A door barricade configured to secure a door comprising:
a. a plate;
b. a fastener;
c. a crossbar;
d. a foot; and
e. a carrying handle.

2. The door barricade of claim 1 further comprising:
f. a door handle cover, wherein said door handle cover is configured to cover a door handle notch present in said plate.

3. The door barricade of claim 1 further comprising:
f. a door skirt.

4. The door barricade of claim 1 further comprising:
f. a mounting bracket; and
g. a side panel, wherein said side panel is configured to attach to said mounting bracket.

5. The door barricade of claim 1 wherein said plate is ridged.

6. The door barricade of claim 1 wherein said plate is bulletproof.

7. The door barricade of claim 1 wherein said fastener is an L-bracket.

8. The door barricade of claim 1 wherein said fastener is a ballistic nylon mechanism.

9. The door barricade of claim 1 wherein said crossbar is telescopic.

10. The door barricade of claim 1 wherein said crossbar is steel.

11. The door barricade of claim 1 wherein said bar includes a locking mechanism.

12. The door barricade of claim 1 further comprising:
f. a second foot, wherein said foot and said second foot are connected via a feet bar.

13. The door barricade of claim 1 wherein said plate is fireproof.

14. The door barricade of claim 1 wherein said plate is made of a nonhomogeneous composition.

15. The door barricade of claim 1 further comprising:
f. a second crossbar.

16. The door barricade of claim 1 wherein said plate is made of a synthetic fiber weave.

17. The door barricade of claim 1 wherein said plate is made of a carbon fiber.

18. The door barricade of claim 1 wherein said plate is made of a liquid crystal polymer.

19. The door barricade of claim 1 wherein said crossbar is configured to engage with a receiving ringlet.

20. The door barricade of claim 1 further comprising:
f. a door handle cover, wherein said door handle cover is configured to cover a door handle notch present in said plate;
g. a door skirt;
h. a mounting bracket; and
i. a side panel, wherein said side panel is configured to attach to said mounting bracket.
